(19) United States
(12) Patent Application Publication
(10) Pub. No.: US 2026/0330407 A1
(43) Pub. Date: Oct. 22, 2026

(54) SYSTEMS AND METHODS OF FACILITATING PHYSICAL PRODUCT RETURN

(71) Applicant: THE CHAMBERLAIN GROUP LLC, OAK BROOK, IL (US)

(72) Inventor: Victor Campos Perez, Tucson, AZ (US)

(21) Appl. No.: 19/650,771

(22) Filed: Apr. 17, 2026

Related U.S. Application Data
(60) Provisional application No. 63/790,359, filed on Apr. 17, 2025.

(51) Int. Cl. G06Q 10/087

(52) U.S. Cl. CPC G06Q 10/08728

(57) ABSTRACT

Systems and methods for processing a returned physical product, including identifying a return context for a physical product; displaying a user interface element corresponding to a first step of a system-defined, sequential inspection workflow; initializing a camera session to capture raw image data of a portion of the physical product; extracting captured product data from the raw image data; verifying the captured product data against a structured data schema associated with the return context to ensure data integrity prior to record finalization; storing the captured product data in a local data store to enable post-capture, pre-submission editing of a record; and upon a triggering event, automatically generating a structured digital file aggregating a plurality of records from the local data store, wherein the structured digital file is formatted for electronic transmission into a reverse logistics database.

### CROSS-REFERENCE TO RELATED APPLICATIONS

The present application claims priority to U.S. Provisional Patent Application Serial No. 63/790,359 filed on Apr. 17, 2025, the disclosure of which is incorporated by reference herein in its entirety.

### FIELD

The present disclosure relates generally to systems and methods for capturing and processing data for returned products within a reverse logistics environment.

### BACKGROUND

Modern commerce is driven in large part by online sales which incur relatively high product return rates, at least compared to traditional brick-and-mortar stores. Conventional methods for handling product returns occur in disjointed, multi-stage, manual processes. Typically, an inspector receives a returned product and must manually capture data from the product, commonly by manually performing manual data entry. Once logged, these data entries often sit for days before they are further processed. At a later time, a different employee, such as a data entry clerk, must retrieve the data entries, interpret the information contained within, and manually transcribe the relevant data into a structured format like an Enterprise Resource Planning (ERP) system.

This conventional approach suffers from several inefficiencies. First, the manual approach introduces latency in the product return cycle. The introduction of delay between physical inspection and data entry creates a significant backlog, slowing the final disposition and potentially tying up valuable warehouse space. This latency also makes it difficult to meet internally and externally motivated deadlines for return processing. Second, reliance on manual data transcription is prone to errors. For example, a data entry clerk may misread a serial number, transpose information, or make another type of typographical mistake. These types of errors create record inaccuracies which affect trend analysis, lead to incorrect disposition decisions, and can result in financial losses. Third, traditional systems rely on additional labor which results in resource strain and additional cost.

Accordingly, a need exists for an improved system and method for processing returned goods that overcome the latency, inaccuracy, and inefficiency inherent in conventional workflows.

### BRIEF DESCRIPTION

Aspects and advantages of the invention in accordance with the present disclosure will be set forth in part in the following description, or may be obvious from the description, or may be learned through practice of the technology.

In accordance with one embodiment, a computer-implemented method for digitally processing a returned physical product via an inspection interface to transform unstructured physical attributes into structured digital records is provided. The method includes identifying, via a processor of a mobile computing device, a return context for a physical product based at least in part on a persistent station identifier; displaying, on a display of the mobile computing device, a user interface element corresponding to a first step of a system-defined, sequential inspection workflow configured to govern a hardware state transition of the mobile computing device; in response to a user interaction with the user interface element, initializing a hardware-integrated camera session of the mobile computing device to capture raw image data of a portion of the physical product; extracting, in real-time by the processor executing a local computer vision engine, captured product data from the raw image data using at least one of optical character recognition (OCR) or barcode scanning; verifying, by the processor of the mobile computing device, the captured product data against a structured data schema associated with the return context to ensure data integrity prior to record finalization; maintaining a persistent state of the persistent station identifier across a plurality of distinct inspection cycles within the workflow; storing the captured product data in a local data store to enable post-capture, pre-submission editing of a record; and upon a triggering event, automatically generating a structured digital file aggregating a plurality of records from the local data store, wherein the structured digital file is formatted for electronic transmission into a reverse logistics database, thereby synchronizing physical product state with digital record accuracy and bypassing a separate manual data transcription step.

In accordance with another embodiment, a reverse logistics inspection system is provided. The reverse logistics inspection system includes a mobile computing device comprising a processor, a memory, a camera, and a display, wherein the memory stores instructions that, when executed by the processor, cause the system to: identify a return context for a physical product based at least in part on a persistent station identifier; present on the display a system-defined sequence of inspection tasks configured to govern a hardware state transition of the mobile computing device; activate the camera to capture raw image data of the returned physical product in response to a prompt from a current inspection task; apply a local computer vision engine to the captured raw image data to extract captured data directly from the returned physical product via at least one of an OCR process or a barcode scanning process; immediately verify the captured data against a structured data schema associated with the return context at an edge of a network to ensure data integrity; store the captured data in a local data store to enable post-capture, pre-submission editing of a record; and based on a triggering event, automatically aggregate a plurality of records from the local data store into a structured digital file formatted for electronic transmission into a reverse logistics database.

In accordance with another embodiment, a non-transitory computer-readable medium storing instructions that, when executed by a processor of a mobile device equipped with a camera, cause the mobile device to perform a method for validating returned goods is provided. The method includes identifying a return context for a physical product based at least in part on a persistent station identifier; enforcing a mandatory, sequential workflow for inspection by presenting a series of interactive prompts on a display of the mobile device configured to govern a hardware state transition of the mobile device; for at least one prompt in the workflow, initiating a live view from the camera to capture real-time identifying information from a surface of the physical product via at least one of OCR or barcode decoding using a local computer vision engine; performing, on the mobile device, a real-time integrity verification by cross-referencing the captured real-time identifying information against a structured data schema associated with the return context; maintaining a persistent state of the persistent station identifier across a plurality of distinct inspection cycles within the workflow; storing the captured real-time identifying information in a local data store to enable post-capture, pre-submission editing of a record; and subsequent to a triggering event, generating a complete and structured digital output file aggregating a plurality of records from the local data store, thereby creating a final data record at a point of physical inspection without an intermediate data entry stage.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of an inspector inspecting physical goods at a station of a warehouse in accordance with embodiments of the present disclosure;

FIG. 2 is a schematic view of a mobile computing device in accordance with embodiments of the present disclosure;

FIG. 3 is a flowchart of an example system-defined, sequential inspection workflow in accordance with embodiments of the present disclosure;

FIG. 4 is a state-machine diagram illustrating a hardware state transition logic in accordance with embodiments of the present disclosure;

FIG. 5 is a flowchart of a data verification and scheme comparison logic in accordance with embodiments of the present disclosure;

FIG. 6 is a mobile computing device as seen executing a context setup in accordance with embodiments of the present disclosure;

FIG. 7 is a mobile computing device advancing to an inspection interface in accordance with embodiments of the present disclosure;

FIG. 8 is a sequential view of the inspection interface in accordance with embodiments of the present disclosure;

FIG. 9 is an editable history log and local data buffer in accordance with embodiments of the present disclosure;

FIG. 9A is a flowchart of an example editing process for a session data in accordance with embodiments of the present disclosure;

FIG. 10 is a performance statistics dashboard interface in accordance with embodiments of the present disclosure;

FIG. 11 is a batch summary as seen on a submission interface in accordance with embodiments of the present disclosure;

FIG. 12 is a fallback option such as encountered when a scan is unsuccessful in accordance with embodiments of the present disclosure; and

FIG. 13 is a qualitative selector in accordance with embodiments of the present disclosure.

### DETAILED DESCRIPTION

The following description relates to technical solutions for digital processing of physical objects, such as returned products, in a reverse logistics environment. This description is provided by way of example and is not intended to be restrictive. For example, while various embodiments are described in the context of a mobile computing device, such as a smartphone, it will be understood that the present disclosure may be implemented across a variety of platforms, including tablets, wearable computing devices (e.g., smart glasses), or specialized industrial internet-of-things (IoT) hardware. The specific examples provided are intended to illustrate the underlying principles of the technology and should not be construed as limiting the scope of the invention to any particular hardware or operating system.

In an embodiment, a computer-implemented method for digitally processing a returned physical product may be provided via an inspection interface configured to transform unstructured physical attributes into structured digital records. The inspection interface may be implemented as a software application instantiated by a mobile computing device, such as a smartphone, tablet, or wearable computing device. The interface can facilitate the direct conversion of physical markings and characteristics (e.g., alphanumeric text, barcodes, or physical damage) into machine-readable data at a point of physical inspection. This may reduce, or even eliminate, manual transcription requirements, e.g., by a data entry clerk.

In some implementations, the method may include identifying, via a processor of a mobile computing device, a return context for a physical product based at least in part on a persistent station identifier. The return context may establish the operational environment for the inspection, such as identifying a specific warehouse location or processing line where the physical product is being handled. The persistent station identifier may include a unique alphanumeric code or a station selector value, such as buttons within the interface which represent distinct physical workstations within a return center.

The method can include displaying, on a display of the mobile computing device, a user interface element corresponding to a first step of a system-defined, sequential inspection workflow. The system-defined, sequential inspection workflow may require specific data points to be collected in a prescribed (non-random) sequence. The user interface element may include button(s), prompt(s), and/or interactive icon(s) that guide an inspector to perform an initial action, such as identifying the returned physical product.

The system-defined, sequential inspection workflow can be configured to govern a hardware state transition of the mobile computing device. As used herein, the term govern is intended to refer to the capacity of the software logic or the system-defined, sequential inspection workflow to direct, control, trigger, manage, or otherwise influence the operational state, power level, or functional availability of one or more hardware-integrated components. The hardware state transition may involve programmatically shifting the mobile computing device from a low-power interface state to an active sensing state. For example, the system-defined, sequential inspection workflow may control an operational state of hardware-integrated components of the mobile computing device, such as a camera, an infrared sensor, and/or a haptic actuator. The system-defined, sequential inspection workflow may ensure such hardware-integrated components are selectively energized and/or utilized when the logic of the system-defined, sequential inspection workflow requires specific data capture or user feedback.

The method may include, in response to a user interaction with the user interface element, initializing a hardware-integrated camera session of the mobile computing device to capture raw image data of a portion of the physical product. The camera session may present a live video feed on the display, allowing the user to align the physical product with one or more optical sensors of the mobile computing device. The raw image data may include single-frame captures or a continuous stream of video frames containing visual information from product labels, manufacturer indicia, and/or packaging. The raw image data may capture a variety of machine-readable symbols, such as barcodes, matrix codes, or Quick Response (QR) codes. In some implementations, the raw image data may capture qualitative physical attributes of the product that represent a current state and/or condition of the physical product. For example, the raw image data may capture visual evidence which may serve as a proxy for identifying whether a unit was previously installed or utilized. Where such visual data appears, a prompt may be generated to trigger a manual binary input or a selection from the inspector, e.g., to confirm presence of the attribute.

In an embodiment, the method can include extracting, in real-time by the processor executing a local computer vision engine, captured product data from the raw image data. The local computer vision engine may utilize on-device processing to analyze the raw image data without requiring sustained connection to a remote server. Extraction may be performed using at least one of optical character recognition (OCR) or barcode scanning to identify and decode alphanumeric strings, one-dimensional barcodes, or two-dimensional matrix codes.

Extracting the captured product data can further, or alternatively, include executing a text-grabbing feature that displays the extracted captured product data as a text overlay on a live video feed to provide the inspector with immediate visual confirmation of the data being read by the computer vision engine. The overlay may highlight specific regions of the raw image data where alphanumeric characters or barcodes have been successfully localized and/or decoded.

The method may include verifying, by the processor of the mobile computing device, the captured product data against a structured data scheme associated with the return context. This verification may ensure data integrity prior to record finalization by checking that the extracted information (e.g., a serial number or model number) conforms to expected lengths, character types, and/or checksums defined by the scheme. In some implementations, verification may include cross-referencing the captured data with locally stored return goods authorization (RGA) records to confirm a match. The locally stored RGA records may be downloaded to the mobile computing device, e.g., during initialization or synchronized periodically, to ensure the device remains functional in warehouse environments characterized by intermittent connectivity. The cross-referencing logic may be configured to compare an extracted unique identifier, such as a serial number or a model number, against a set of expected identifying information contained within the locally stored RGA record to validate that the physical object being inspected corresponds to the specific unit authorized for return.

In some embodiments, the method can include maintaining a persistent state of the persistent station identifier across a plurality of distinct inspection cycles within the workflow. This may be referred to as sticky logic and may allow a station selector value to stay fixed after an initial selection until a user manually changes the selection. By maintaining this state, the system reduces the cognitive load and repetitive input required from the inspector, as the station metadata is automatically associated with every product scanned during a session.

Maintaining a persistent state of the persistent station identifier may involve storing a user-selected variable in a memory of the mobile computing device that remains active for the duration of a defined inspection session. The persistent station identifier may include, for example, a specific workstation designation, (e.g., "Station 1") corresponding to a physical location or processing line within a reverse logistics facility. By way of non-limiting example, once a user selects a specific workstation designation at the initiation of a work shift or session, e.g., restocking, the system may be configured to automatically apply this value into the device's current operational context. Such sticky logic may allow the persistent station identifier to be automatically associated as metadata with each individual record in a plurality of distinct inspection cycles without further user intervention. In some implementations, the system-defined, sequential inspection workflow may be configured to programmatically inject the specific workstation designation into a data field for every product scanned or manually entered during the session. This automated association can ensure that every record aggregated into the final structured digital file contains consistent location metadata, which may facilitate the automated sorting and ingestion of the data by a central reverse logistics database. As a result, the system may provide a technical solution to the problem of high-volume, repetitive data entry, which can otherwise lead to inspector fatigue and increased error rates.

The system may be configured to maintain this persistent state until a manual user override is detected. A manual user override may include a specific interaction with a settings menu or a re-selection of a different station selector value on a data collection screen. Upon detection of such an override, the system can update the persistent station identifier in the local memory, and subsequent records captured from that point forward may be associated with the new station identifier until another override occurs or the session is terminated. Alternatively, or in addition, the persistent state may terminate upon occurrence of a threshold condition, such as upon detecting an end of shift condition.

In one or more implementations, the persistent station identifier may be determined at least in part via spatial proximity mapping. The mobile computing device can utilize an ultrawideband (UWB) transceiver or Bluetooth Low Energy (BLE) Received Signal Strength Indicator (RSSI) to detect precise physical coordinates relative to a plurality of fixed location beacons disposed at each workstation. Upon detecting that the mobile computing device has entered a defined geofence or proximity radius (e.g., within 2 feet) of a specific physical workstation, the system-defined, sequential inspection workflow automatically updates the persistent station identifier metadata. This ensures that the inspection context is aligned with the physical location of the device, eliminating the risk of data corruption that occurs when an inspector relocates to a different processing line but neglects to manually update the station selector value.

The method can further include storing the captured product data in a local data array to enable post-capture, pre-submission editing. The local data array may be stored in memory of the mobile computing device. As a result, the inspector can review captured data points and perform corrections and/or deletions prior to submission.

In one or more implementations, the method may include, upon a triggering event, automatically generating a structured digital file aggregating a plurality of records from the local data array. The triggering event may include a user-initiated submission interaction, such as tapping a submit or export button. Alternatively, or in addition, the triggering event may be a time-based such as the end of a shift. The aggregation process may combine individual product records into a single consolidated file transmittable to the reverse logistics database.

The structured digital file may be formatted for electronic transmission into a reverse logistics database, thereby synchronizing physical product state with digital record accuracy. In an embodiment, the structured digital file may be a Comma Separated Values (CSV) file, though other formats such as XML or JSON are contemplated. This digital output can be directly ingested by a central management system, bypassing manual data transcription steps that characterize conventional inspection processes.

Automatically generating the structured digital file may include automatically composing an electronic mail message (e-mail) with the CSV file, or another file type, attached for user-initiated submission. The system may utilize pre-established email accounts and settings associated with the mobile device to pre-populate recipient addresses, subject lines, and/or body text of the e-mail. The inspector may be able to review the aggregated data one final time before initiating the transmission of the records to a centralized server.

In one or more implementations, the method may include a continuous synchronization engine configured to transmit records from the local data array to a remote reverse logistics database in real-time via an event-driven architecture. Rather than relying on a terminal triggering event (such as the end of a shift), the system may utilize an industrial messaging protocol (e.g., Message Queuing Telemetry Transport (MQTT)) to stream encrypted data immediately upon successful verification of an individual record.

In an embodiment, the systems and methods described herein may provide a manual data entry mode. The manual data entry mode may act as a fallback input for the system-defined, sequential inspection workflow. This fallback input may be triggered in response to a determination that the computer vision engine is unsuccessful in extracting data, such as when a label is physically obstructed or unreadable. In response to relying on the fallback input, the system may generate an ability for the inspector to enter information. For example, the mobile computing device may execute a virtual keyboard. The system may receive the captured product data, e.g., via the virtual keyboard displayed on the display, ensuring the inspection workflow can continue even when automated scanning is not possible.

The method may further include providing, e.g., via at least one of a speaker or a haptic engine, an audible and/or tactile confirmation to the inspector. The confirmation can be triggered, e.g., in response to successfully extracting data, successfully verifying a record, and/or receiving a submission interaction via a submit button. In some implementations, the user may customize these feedback profiles by selecting from a library of distinct notification sounds or vibration patterns.

The method can include calculating, e.g., locally on the mobile computing device, at least one performance statistic associated with the system-defined, sequential inspection workflow. By processing timestamps for every scan and submission event, the mobile computing device, or another processor, can generate real-time metrics such as a total submission count, an average submission time, an average time between entries, or the like. Such statistics can be displayed on a performance tracker, e.g., a local display, providing the inspector with immediate feedback on their operational efficiency.

In one or more embodiments, the sequential inspection workflow can include an interactive prompt for a manual binary input from a user. The manual binary input may correspond to a visual confirmation of a specific physical attribute that may not be easily captured by automated sensors. For example, the system-defined, sequential inspection workflow may require the user to toggle a switch or check a box confirming the presence or absence of markings or damage on a product surface, which serves as a qualitative indicator of the product's prior use.

The mobile computing device used in the system can include a ruggedized housing suitable for warehouse environments. The ruggedized housing may include shock-absorbent materials and ingress protection (IP) sealing to protect the internal processor, memory, and camera from physical impacts, dust, and moisture prevalent in industrial settings.

The mobile computing device may include a display. In some implementations, the display may be configured with a capacitive touch interface that supports touch interaction, allowing an inspector to navigate the system-defined, sequential inspection workflow without removing protective equipment.

The mobile computing device may include a multi-core application processor capable of executing high-speed image processing algorithms. The multi-core application processor may be configured to allocate specific hardware resources, such as a dedicated neural processing unit (NPU) and/or a graphics processing unit (GPU), to execute the high-speed image processing algorithms of the local computer vision engine. The specialized hardware allocation may allow for the real-time extraction of captured product data with minimal latency, even when processing high-resolution raw image data. By performing computationally intensive tasks locally at the edge, the system may reduce the power consumption associated with frequent wireless data transmissions and avoid the delays inherent in server-side processing architectures.

The mobile computing device can be configured to operate in an offline mode, where all data extraction and verification occur locally, and data is queued for transmission once network connectivity is established or the triggering event occurs. In an embodiment, the offline mode may be supported by the local data array configured as a persistent database, such as a SQLite or Realm database, within the memory of the mobile computing device. This local data store may be configured to maintain the integrity of unsubmitted records across power cycles or application restarts. For example, if the device undergoes an unexpected shutdown, the system may be configured to retrieve the unsubmitted records from the local history log upon reboot, ensuring that no inspection data is lost.

The mobile computing device may be configured to monitor a network state and automatically synchronize the aggregated records, e.g., in response to detecting a stable connection (e.g., Wi-Fi or cellular). In some implementations, the triggering event for generating the structured digital file may be programmatically linked to the detection of a network handshake, allowing for a seamless transition of data from the edge device to the reverse logistics database without requiring the user to manually re-initiate the submission process.

In some implementations, the system may present a user interface that allows a user to select, edit, or delete a previously stored unsubmitted record from a local history log. Each entry in the history log may display a summary of the captured data, such as a serial number and a timestamp, allowing the user to quickly identify and rectify mistakes before the data is committed to the central database.

The mobile computing device, or another processor, may be configured to calculate performance statistics. While the calculation of performance statistics may occur locally at the edge, the mobile computing device can optionally be configured to synchronize with a remote server for the creation of leadership dashboards or aggregated reports which aggregate performance statistics from a plurality of mobile computing devices, allowing for quick review of facility-wide metrics. Performance statistics can be formatted to compare an individual's current performance against a team average or a pre-defined shift goal. In some implementations, this formatting may involve a visual representation on the display of the mobile computing device, such as a dashboard or a summary widget, that highlights whether current productivity is within a threshold. By comparing real-time data to a baseline or a team-wide metric, the system can provide a technical solution for identifying operational bottlenecks at specific workstations and ensuring team members are following best practices.

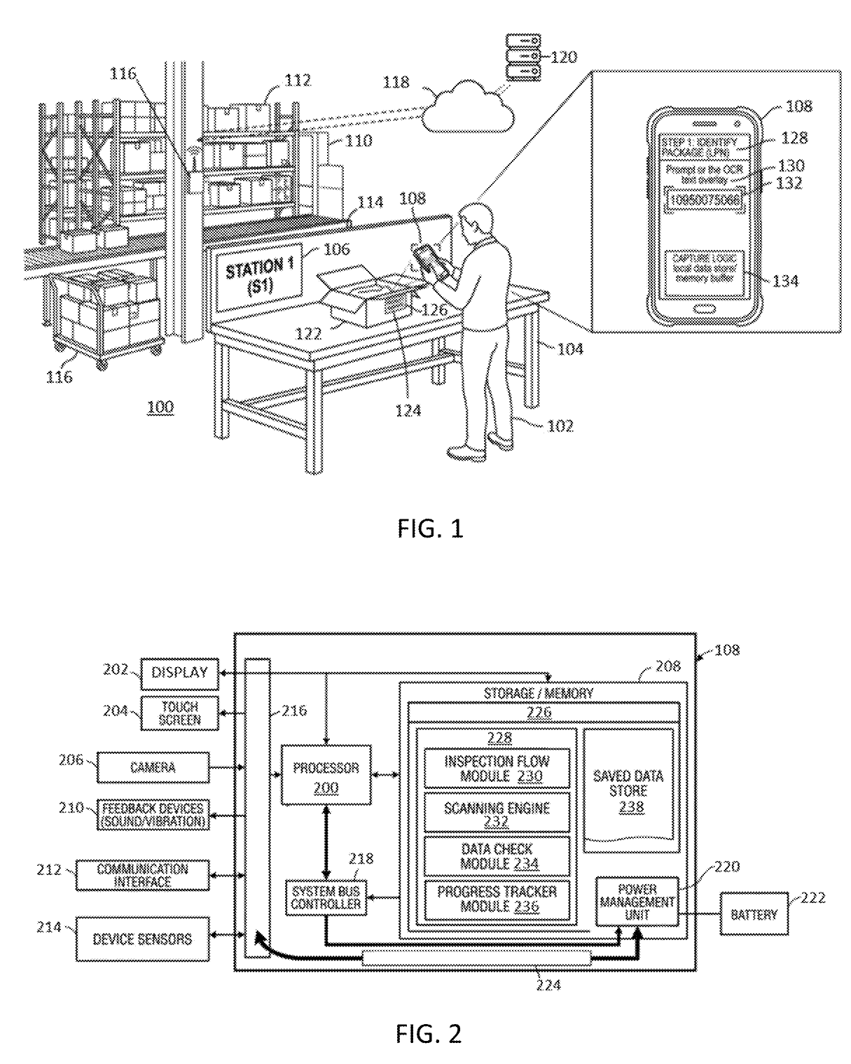

Referring now to the drawings, FIG. 1 illustrates a warehouse facility 100, such as a reverse logistics facility. The warehouse facility 100 may be part of a larger distribution center, such as a fulfillment and returns center. Alternatively, the warehouse facility 100 may be standalone facility. The warehouse facility 100 is staffed by one or more human inspectors 102 and/or autonomous, or semi-autonomous, inspectors.

The warehouse 100 may include one or more stations 104, such as a plurality of stations 104. The station(s) 104 may be labeled with a station identifier 106, e.g., with one or more alphanumeric indicia. For example, a first station 104 may be labeled “STATION 1 (S1)”. A second station (not illustrated) may be labeled “STATION 2 (S2)”. A third station (not illustrated) may be labeled “STATION 3 (S3)”. And so on. The station identifier 106 may denote a particular station location within the context of the aerial footprint of the warehouse 100, a station type (e.g., a standing station, a sitting station, a sitting-standing station, etc.), an operation to be performed at the station (e.g., returns, exchanges, etc.), a particular vendor, or the like. In some instances, the station identifier 106 may include one or more machine-readable symbols, such as a barcode, a matrix code, and/or a QR code. The machine-readable symbols may be captured by a mobile computing device 108 to sync operations described herein to the correct station 104.

The warehouse 100 may include a package depot 110 where one or more physical packages 112 are located. The package depot 110 may house physical packages 112 that have not yet been processed, that are being processed, and/or that are already processed and ready for final disposition (e.g., restocking, etc.). A transport system may be used to move physical packages 112 to and/or from the package depot 110 to one or more of the station(s) 104. The transport system may include, for example, conveyers 114 (e.g., conveyer belts, or roller systems), dollies 116, or the like.

One or more wireless connectivity devices 116 may be arranged throughout the warehouse 100. The wireless connectivity device(s) 116 may include, for example, access points (APs) configured to provide wireless connectivity to a network 118, such as the Internet, for communication between the mobile computing device 108 and a server 120 or other remote computing device.

The inspector(s) 102 may each be assigned one or more mobile computing devices 108, such as smart phones, tablets, wearable computing devices (e.g., smart glasses), and/or specialized industrial internet-of-things (IoT) hardware.

FIG. 2 is a schematic view of the mobile computing device 108 as seen in accordance with an example embodiment. The mobile computing device 108 can include a processor 200, such as a multi-core application processor capable of executing high-speed image processing algorithms. In the case where the mobile computing device 108 is a smartphone, the processor 200 may include one or more central processing units (CPUs) and a graphical processing unit (GPU) associated with a native on-board processor communicatively coupled to non-transitory computer-readable memory storing instructions executable by the processor(s) 200.

The mobile computing device(s) 108 may include a human-machine interface, such as a display 202, which allows a user to interact with the mobile computing device 108. By way of non-limiting example, the display 202 may include a backlit display (e.g., an LCD display, an LED display, a QLED display, etc.), a self-lighting display (e.g., an OLED display, etc.), an electronic paper (E-Ink) display, or the like. The display 202 may include a touch screen 204 that receives input from the inspector 102 (FIG. 1). The touch screen 204 may enable use of selectable icons, a digital keyboard, and other user controllable functionality.

The mobile computing device(s) 108 may further include an image capture device, such as a camera 206. The camera 206 may include an optical stack (e.g., a lens assembly, an aperture, an infrared (IR) cut-off filter, a cover layer, etc.), an image sensor (e.g., a complementary metal-oxide semiconductor (CMOS), a photodiode, a color filter array (CFA), an analog-to-digital converter (ADC), etc.), a stabilization stack (e.g., a voice coil motor (VCM), an optical image stabilization (OIS) system, an electronic image stabilization (EIS) system, etc.), a processing system (e.g., an image signal processor (ISP), a flash, a time of flight (ToF) sensor, etc.), and/or other components. The camera may be controllable by the processor 200 in view of instructions stored at memory 208 to capture raw image data that can be used to perform one or more operations described herein.

The mobile computing device 108 can further include a feedback device 210, such as a microphone and/or haptic vibration device. The feedback device 210 may receive control signals which affect generation of user feedback. For example, when the camera 206 captures raw image data that is determined to satisfy a particular requirement for one or more operations described herein, the processor 200 may generate a control signal to energize the feedback device 210. The feedback device 210 may then generate the user feedback so the inspector 102 (FIG. 1) quickly identifies completion of the current task and enables quicker response time and throughput.

The mobile computing device 108 can further include a communication interface 212. The communication interface 212 may include communication circuitry which enables the mobile computing device 108 to communicate with one or more wired and/or wireless devices. For example, the communication interface 212 may include a physical port configured to receive a wired connection to electronically connect the mobile computing device 108 to one or more local devices at the station 104 (FIG. 1). Alternatively, or in addition, the communication interface 212 can include wireless communication enabling components such as an antenna configured to communicate with the wireless connectivity devices 116 (FIG. 1). By way of example, the antenna may be a Bluetooth antenna, a WiFi antenna, or the like. In some instances, the communication interface 212 may be configured with a plurality of antennas for communication via a plurality of different communication protocols.

The mobile computing device 108 may further include one or more device sensors 214. By way of non-limiting example, the device sensors 214 may include location-detection sensor(s) (e.g., a global navigation satellite system (GNSS) receiver), an accelerometer, a gyroscope, a pedometer, an ultrawideband (UWB) sensor, an ambient light sensor, a proximity sensor, a biometric scanner (e.g., a fingerprint scanner, a face identification camera, etc.), or the like.

The components of the mobile computing device 108 may be integrated together through a control interface 216 in communication with the processor 200. A system bus controller 218, or the like, may communicate with a power management unit 220 to control a battery 222 and one or more hardware states.

The memory 208 may store the operating system 226 and an application 228 associated with one or more operations described herein. The application 228 may include one or more modules, such as an inspection flow module 230, a scanning engine 232, a data check module 234, and/or a progress tracker module 236. Data 238, such as data obtained through use of the application 228, may be stored at the memory 208.

Referring again to FIG. 1, the mobile computing device 108 may be used to perform one or more operations, or one or more steps of said operations, as described herein. For example, the camera 206 (FIG. 2) of the mobile computing device 108, may be used to capture raw image data associated with a portion of a physical product 122 currently being reviewed at the station 104. For example, the inspector 102 may generate a user input at the display 204 (FIG. 2) that causes the processor 200 to energize the camera 206. Once energized and in an image-capture condition, the physical product 122 may be introduced into the field of view of the camera 206 to generate raw image data of the physical product 122. The raw image data may include identifying aspects 124 of the physical product 122, such as a barcode, an alphanumeric name 126, a mailing label, or the like.

During the operations described herein, the mobile computing device 108 may execute a system-defined, sequential inspection workflow. The system-defined, sequential inspection workflow may guide the inspector 102 through the operation(s) in a sequential step-by-step process. For example, the system-defined, sequential inspection workflow may generate an indication 128 of a first step in the operation. The first step may include identifying the physical product 122. The system-defined, sequential inspection workflow may generate instructions 130 usable by the inspector 102 to perform the associated first step. The instructions 130 may include a short description of the action(s) to be taken, a desired result, instructions for improving the action (e.g., “move camera to the left”, “get closer to the label”, etc.), or the like.

The system-defined, sequential inspection workflow may also generate an identifying output 132 which allows the inspector 102 to quickly reference the identifying aspects 124 of the physical product 122. For example, where the inspector 102 points the camera 206 towards a product label associated with the physical product 122, the mobile computing device 108 may identify a barcode or string of alphanumeric text which are then scanned, e.g., using an OCR tool, and reproduced at the identifying output 132. The mobile computing device 108 may process captured image data by either mapping a specific region of interest to a predetermined coordinate on the display for direct visual reproduction, or by semantically extracting information to be reconstructed using native device fonts and interface elements. This methodology enables the device to provide both a pixel-level representation of the original source and/or a synthesized digital output based on the interpreted content. These distinct modes allow for the simultaneous or selective provision of raw image verification and structured, machine-readable data visualization.

The system-defined, sequential inspection workflow may identify additional information 134 associated with the physical product 122 or operation, alert the inspector 102 of next steps, or provide other contextual information, e.g., via a notification engine executed by the mobile computing device 108. The additional information may vary on a context-dependent basis. The additional information 134 may be generated in real time as new conditions and information are detected.

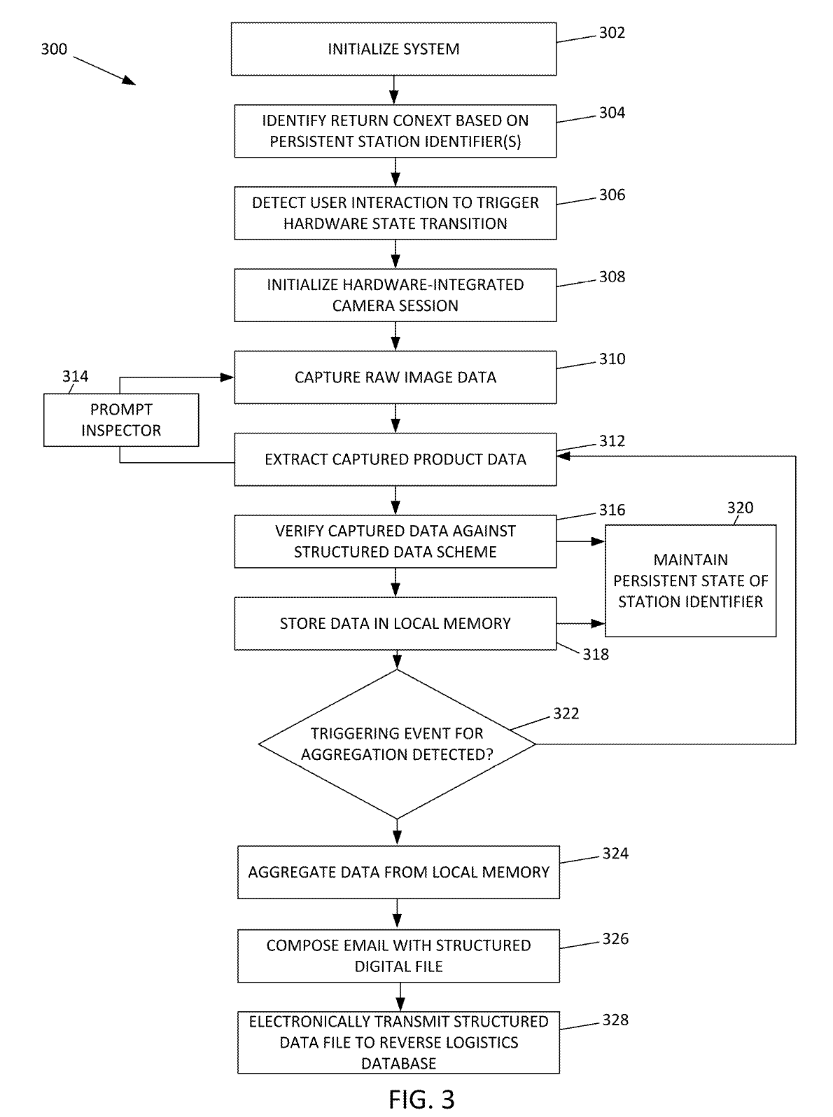

Referring now to FIG. 3, a flowchart of an example system-defined, sequential inspection workflow 300 is depicted. The system-defined, sequential inspection workflow 300 includes on-device capture, local verification logic, post-session aggregation, and submission. In general, the system-defined, sequential inspection workflow 300 will be described with reference to a system including the station 104 and mobile computing device 108 of FIGS. 1 and 2. Although FIG. 3 depicts steps performed in a particular order for purposes of illustration and discussion, the system-defined, sequential inspection workflow discussed herein is not limited to any particular order or arrangement. One skilled in the art, using the disclosure provided herein, will appreciate that various steps of the system-defined, sequential inspection workflow disclosed herein can be omitted, rearranged, combined, and/or adapted in various ways without deviating from the scope of the present disclosure.

The system-defined, sequential inspection workflow 300 may initialize 302 when the mobile computing device loads an application associated with the system-defined, sequential inspection workflow into allocated memory. During this phase, the mobile computing device may verify an operational status of integrated hardware, such as an onboard camera, and authenticates the inspector to synchronize the local verification logic with the requirements of the specific inspection session. The system-defined, sequential inspection workflow 300 may identify 304 return context based on one or more persistent station identifiers. For example, the mobile computing device may establish a communication link with the station to retrieve inspection protocol(s) and product metadata. The station identifier may be stored in local memory for reference during inspection session(s).

The system-defined, sequential inspection workflow 300 may wait in the initialized state until detecting 306 a user interaction. Upon detecting the user interaction, the mobile computing device may trigger a hardware state transition and initialize 308 a hardware-integrated camera session. To initialize the hardware-integrated camera session, one or more onboard processors can command hardware-level capture components to energize and stabilize the camera stack for image capture. The system-defined, sequential inspection workflow 300 can then be used, e.g., by the inspector, to capture 310 raw image data. For example, the inspector can move the mobile computing device relative to the physical product being scanned and/or move the physical product until identifying information is captured in the camera’s field of view. The system-defined, sequential inspection workflow 300 may then extract 312 captured product data, e.g., using a multi-mode processing operation. In a first mode, the system identifies a region of interest (ROI) within the raw image data and maps said ROI to a predetermined coordinate on a graphical user interface (GUI) for direct pixel-accurate reproduction. In a second mode, identifying information is semantically parsed from the raw image data and reconstructed at the identifying output 132 using native device assets, such as system fonts and vector-based interface elements. By way of non-limiting example, the extracted captured product data may include serial numbers, barcodes, shipping information, and/or other indicia associated with the physical product. Where the extracted captured product data is insufficient for processing (e.g., fails to meet a predetermined optical character recognition (OCR) confidence threshold, exhibits motion blur above a tolerance limit, or is otherwise unavailable for later operations), the mobile computing device (or another user-machine interface) may prompt 314 the inspector to repeat the capture 308.

The system-defined, sequential inspection workflow 300 may further include verifying 316 captured data against a structured data scheme. For example, the captured data can be compared to a data scheme using a validation engine to determine correct formatting, valid information, or the like. The data may then be stored 318 locally at the mobile computing device. The mobile computing device can maintain 320 the persistent state of the station identifier during one or more steps of the system-defined, sequential inspection workflow 300, such as during verifying 316 and storing 318.

The inspector may repeat steps 304 to 318 (or any combination of the aforementioned steps associated with the system-defined, sequential inspection workflow 300) during their shift for a plurality of physical products crossing the station. In many instances, the inspector remains at the same station throughout their shift, thereby eliminating the need for updates to the station identifier. However, in some instances, the inspector may shift between two or more stations during their shift. In this case, the station identifier may be periodically updated (manually or automatically) in response to the inspector relocating stations. The station identifier may remain associated with the current station until the inspector again moves to another station.

Throughout the inspector’s shift, or at the end of their shift, the system-defined, sequential inspection workflow 300 may detect a triggering event 322 for aggregation of the stored data. The triggering event 322 includes a bounding event after which the output from the preceding steps is aggregated 324 from the local memory. The bounding event may include, for example, completion of a shift, completion of a predetermined interval (e.g., every 2 hours), an access or power condition (e.g., a previous low bandwidth condition restored above a threshold bandwidth), or the like.

Aggregating 324 the data from local memory may include compiling a plurality of captured product data entries into a structured data file associated with a specific inspection session. For example, aggregating 324 can include appending metadata to the extracted product data, such as the persistent station identifier, an inspector credential, and a temporal synchronization marker (e.g., a timestamp). A data integrity check may be performed on the aggregated file to ensure that the semantic reconstructions match the original pixel-level regions of interest before clearing the local memory. Finally, the aggregated data is formatted into a transmission-ready state (e.g., a CSV, a JSON or XML scheme) optimized for submission to a remote server or a centralized inspection database.

The system-defined, sequential inspection workflow 300 may include composing 326 an email with the structured data file and electronically transmitting 328 the structured data file to a reverse logistics database via an application programming interface (API) or a similar networked gateway.

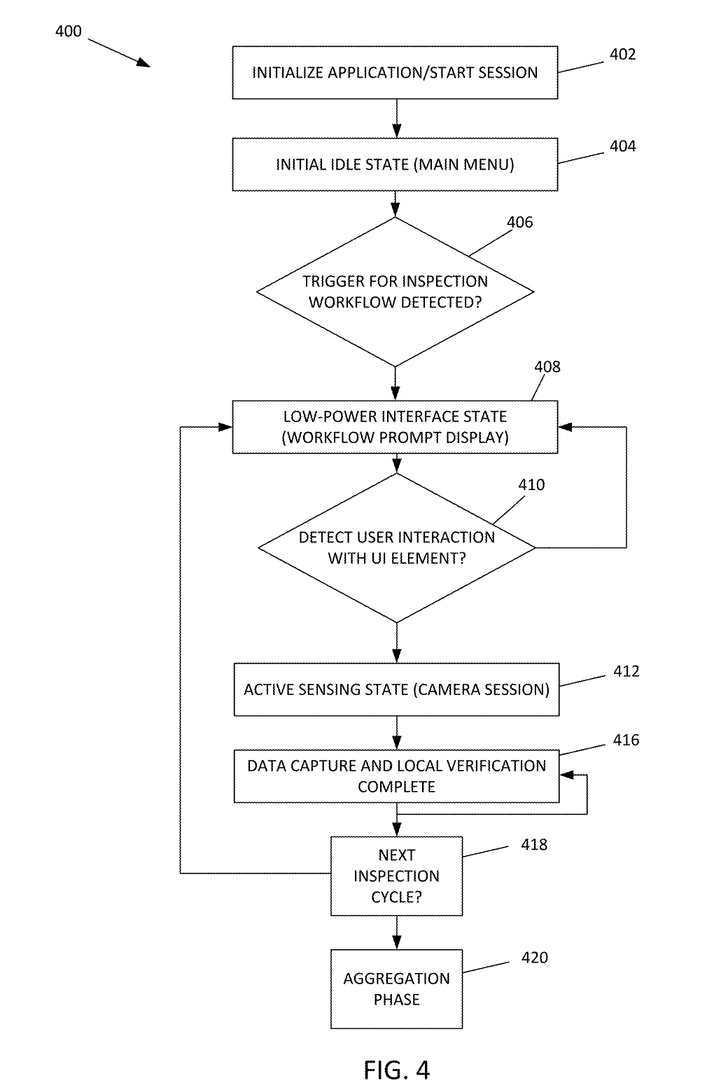

FIG. 4 illustrates a state-machine diagram illustrating a hardware state transition logic 400 in accordance with an example embodiment. In general, the hardware state transition logic 400 will be described with reference to a system including the mobile computing device 108 of FIGS. 1 and 2. Although FIG. 4 depicts steps performed in a particular order for purposes of illustration and discussion, the system-defined, sequential inspection workflow discussed herein is not limited to any particular order or arrangement. One skilled in the art, using the disclosure provided herein, will appreciate that various steps of the system-defined, sequential inspection workflow disclosed herein can be omitted, rearranged, combined, and/or adapted in various ways without deviating from the scope of the present disclosure.

The hardware state transition logic 400 includes governing logic. The mobile computing device begins in an initial idle state from which an application is initialized and a scanning session is started 402. In some embodiments, this involves shifting the application from a background execution mode to a foreground focal state to increase CPU frequency and allocate higher priority to image processing threads. The mobile computing device remains in an idle state 404. In the idle state, a main menu may be presented to prompt a user to begin a scanning session. Upon a workflow trigger 406, e.g., a new shift begins, a user interacts with the mobile computing device, etc., the mobile computing device can enter a low-power interface state 408. The low-power interface state 408 can include a workflow prompt display. In response to detecting 410 a user interaction with a UI element, the hardware state transition logic 400 can initiate an active sensing state 412. Initiating the active sensing state 412 may trigger a hardware-level interrupt to energize the image sensor and stabilize the lens assembly (e.g., voice coil motor) for high-speed frame ingestion. Data capture 416 is then performed and local verification is completed, wherein the system determines whether to apply the mapping or semantic reconstruction mode, e.g., based on the visual properties of the captured frame. The hardware state transition logic 400 then waits for the next inspection cycle 418, or, in response to a failed verification, transitions back to the active sensing state 412 for a remedial capture. The system continues looping steps 408 to 418 until an aggregation phase 420 is triggered by a bounding event, causing the hardware to de-energize the camera stack and transition back to the idle state 404.

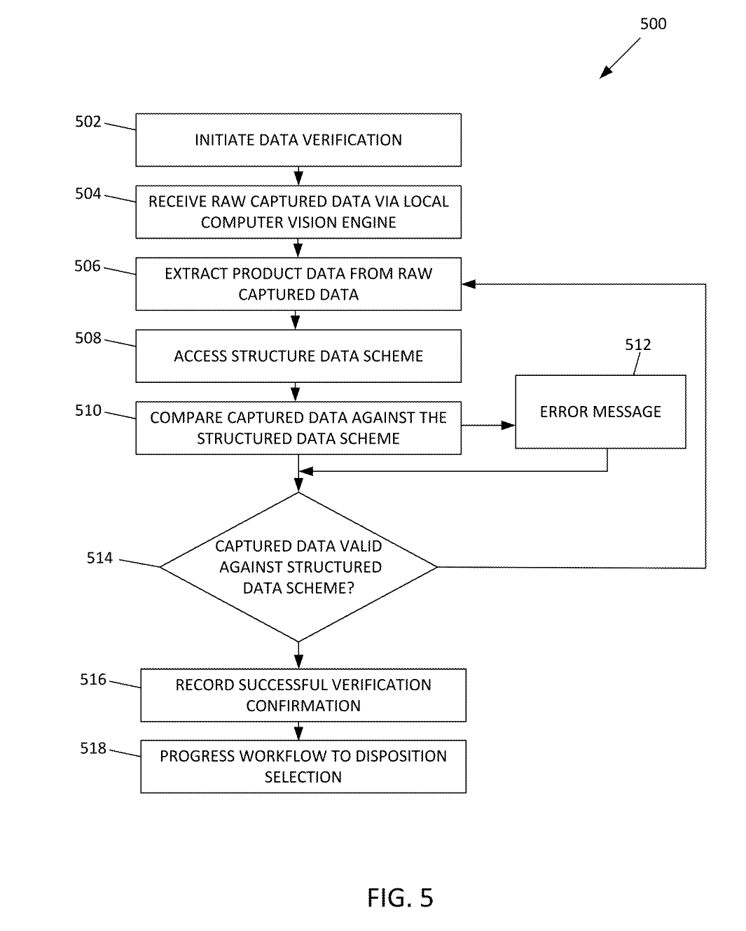

FIG. 5 illustrates a flowchart of a data verification and scheme comparison logic 500 in accordance with an embodiment. In general, the hardware state transition logic 400 will be described with reference to a system including the mobile computing device 108 of FIGS. 1 and 2. Although FIG. 5 depicts steps performed in a particular order for purposes of illustration and discussion, the system-defined, sequential inspection workflow discussed herein is not limited to any particular order or arrangement. One skilled in the art, using the disclosure provided herein, will appreciate that various steps of the system-defined, sequential inspection workflow disclosed herein can be omitted, rearranged, combined, and/or adapted in various ways without deviating from the scope of the present disclosure.

The data verification and scheme comparison logic 500 includes initiating 502 the data verification. Initiating 502 may begin in response to image capture. The data verification and scheme comparison logic 500 further includes receiving 504 raw captured data via a local computer vision engine. The data verification and scheme comparison logic 500 may cause extraction 506 of product data from the raw captured data. The data verification and scheme comparison logic 500 may then access 508 a structured data scheme and compare 510 the captured data against the structured data scheme. Where the comparison 510 does not return a match, an error message 512 is generated. The captured data is then analyzed to determine whether it is valid against the structured data scheme. Where the data is valid, the data verification and scheme comparison logic 500 includes recording 516 successful verification confirmation and progressing 518 the workflow to a disposition selection.

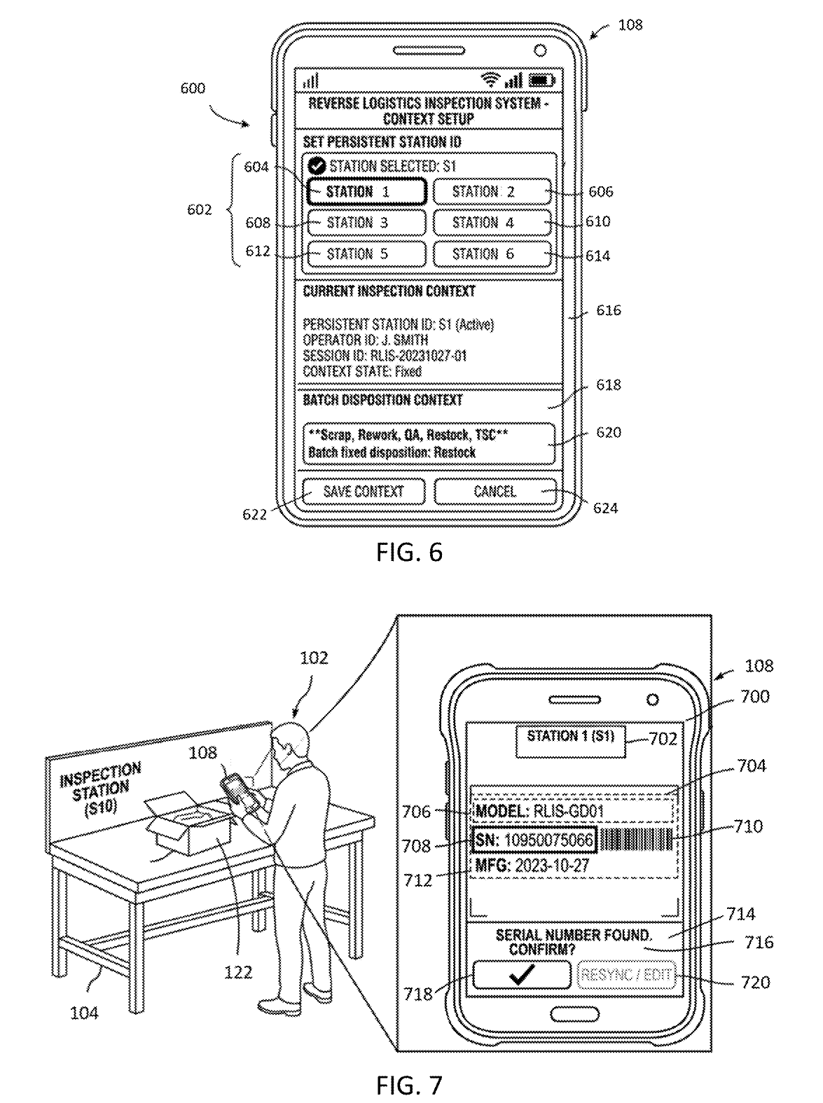

FIG. 6 illustrates the mobile computing device 108 as seen executing a context setup 600 associated with operations described herein in accordance with an example embodiment. The context setup 600 may include an initial step in the workflow described herein. The context setup 600 may include a screen that allows the inspector to affect an initial setup of a shift or adjust context during a shift. Once set (i.e., once input by the inspector), the context setup 600 may not appear again unless manually called by the inspector to adjust the context. The context setup 600 may be accessible through a menu of the application.

The context setup 600 may include a station identifier selector 602. An inspector may set the station identifier by selecting between a plurality of options, such as a first option 604 associated with a first station, a second option 606 associated with a second station, a third option 608 associated with a third station, a fourth option 610 associated with a fourth station, a fifth option 612 associated with a fifth station, and a sixth option 614 associated with a sixth station. In the depicted embodiment, the first option 604 is selected, indicating that the mobile computing device is being associated with the first station 104 (FIG. 1). The selected station may remain as a persistent station identifier until changed, e.g., manually by the inspector, in view of location information, in view of connectivity information, or the like.

The context setup 600 may define current inspection context 616. The current inspection context 616 may include contextual information associated with the shift and/or operation. By way of example, the current inspection context 616 may include an inspector identifier associated with the current inspector managing the mobile computing device, a session identifier (e.g., a shift designation, time, date, etc.), a current state in the operation workflow, and/or other information. In some instances, the current inspection context 616 may remain fixed between multiple scanned physical products. The context setup 600 may further include a batch disposition context 618 which can include information 620 associated with the current context state (e.g., the station is a restocking station, a rework station, etc.). For example, the information 620 may define the station (e.g., the physical product is intended for restock, rework, etc.). The user interface 600 may include user action buttons (such as digital icons 622, 624) which allow the inspector to save context, cancel the context (e.g., in preparation for preparing a new scan), or the like.

With context setup complete, the application may advance the user interface to an inspection interface 700, such as depicted in FIG. 7, through which the inspector 102 can actively scan physical products 122. For example, the application may advance the user interface to the inspection interface 700 in response to the inspector selecting the icon 622 (FIG. 6).

The inspection interface 700 can identify the station identifier 702 to ensure the mobile computing device 108 is not misplaced at a different station. The inspection interface 700 may also identify information 704 associated with the current physical product being scanned. The identifying information 704 may include, for example, model information 706 associated with the current physical product, an alphanumeric serial number 708, indicia 710, and/or other information 712. The inspection interface 700 can further include an inspector confirmation feature 714 through which the inspector 102 can confirm the identified information 704. By way of example, the inspector confirmation feature 714 can include a prompt 716 that notifies the inspector 102 what they are confirming. The inspector confirmation feature 714 can include a confirmation input 718. The inspector confirmation feature can include an edit or reject input 720 through which the inspector can access the information to provide edits or reject the information 704.

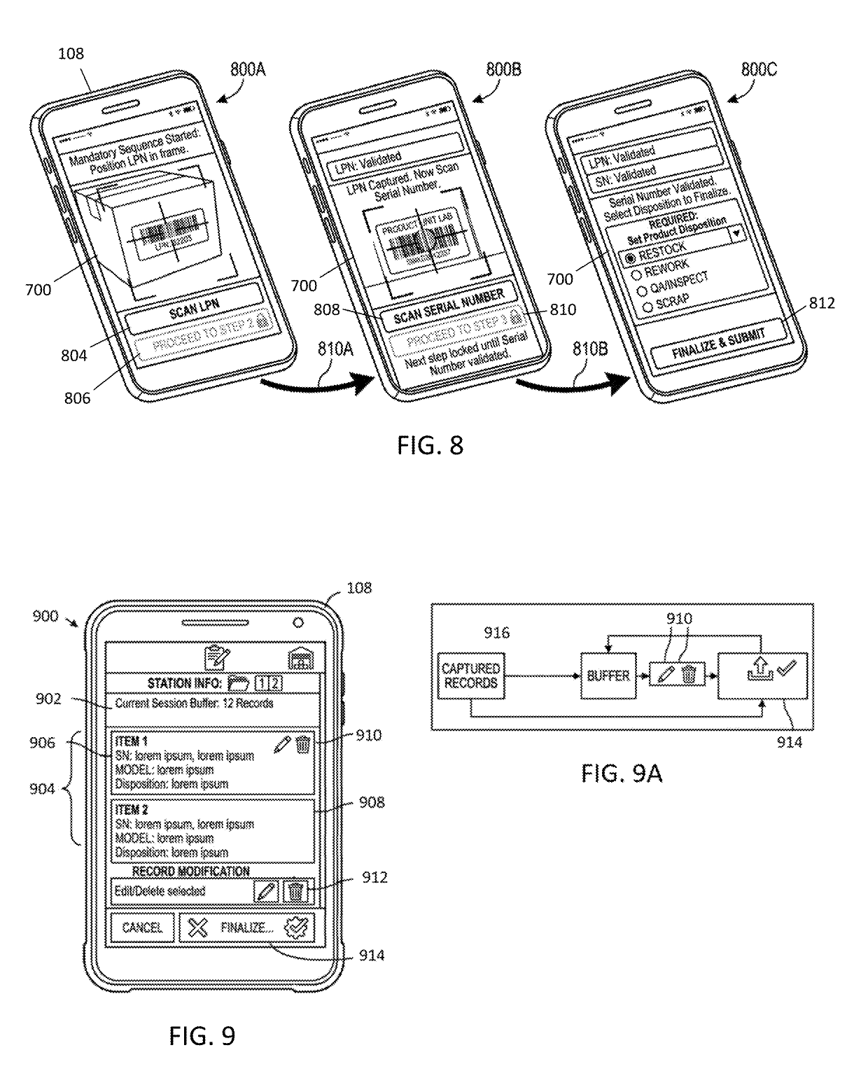

FIG. 8 illustrates a sequential view of the inspection interface 700 displayed on the mobile computing device 108 in accordance with an embodiment as the inspector proceeds through a plurality of steps after context setup 600 is complete. In particular, FIG. 8 illustrates the inspection interface 700 as seen in a first instance 800A, a second instance 800B, and a third instance 800C, respectively. The second instance 800B occurs after the first instance 800A and the third instance 800C occurs after the second instance 800B. The inspection interface 700 may transition 810A from the first instance 800A to the second instance 800B and transition 810B from the second instance 800B to the third instance 800C.

In the first instance 800A, the inspection interface 700 can assist the inspector in positioning the physical package within the camera’s field of view. In some implementations, the inspection interface 700 can generate prompts to align the physical package (e.g., “move camera left”). In other implementations, the inspection interface 700 may also, or alternatively generate spatial prompts (e.g., an arrow pointing left) to assist the inspector in aligning the physical package. In yet other implementations, the mobile computing device 108 may be caused to generate an audible and/or tactile indication to the inspector to assist in aligning the physical package. In certain instances, the inspection interface 700 may restrict advancing to the second instance 800B until the physical package is properly aligned. For example, a user selection 804 may be grayed out until the package is properly aligned. By selecting the user selection 804, the camera may be caused to capture raw image data. The inspection interface 700 may then unlock a user selection 806 permitting advancement to the second instance 800B. In the second instance 800B, the inspector may be prompted to capture an image of identifying information. A user selection 808 to scan the identifying information may be selected followed by a user selection 810 to advance the inspection interface 700 to the third instance 800C. The third instance 800C may allow the user to select particular information based on the context of the physical package return. Once completed, the inspector may select a user selection 812 associated with saving data associated with the physical package on local memory.

FIG. 9 illustrates an editable history log and local data buffer 900. The editable history log and local data buffer 900 may be accessible through a menu of the application. Using the editable history log and local data buffer 900, the inspector may revisit previous session data, e.g., to affect edits/updates and/or to view information associated with previous session data. The editable history log and local data buffer 900 can include a session count 902, session history 904 (such as first session data 906, second session data 908, etc.), and the like. Each session data 906, 908 may be editable using selectable icons 910. Session history 904 (or parts thereof) may be batch edited or deleted using selectable icons 912. When the inspector is done referencing the editable history log and local data buffer 900, user selectable icons 914 may be selected.

Box 9A depicts a flowchart of an example editing process for a session data 916. The session data 916 may be buffered by local memory and the inspector can utilize selectable icons 910 to affect modification to the session data 916. After modification is complete, the inspector can use selectable icons 914 to complete the editing process.

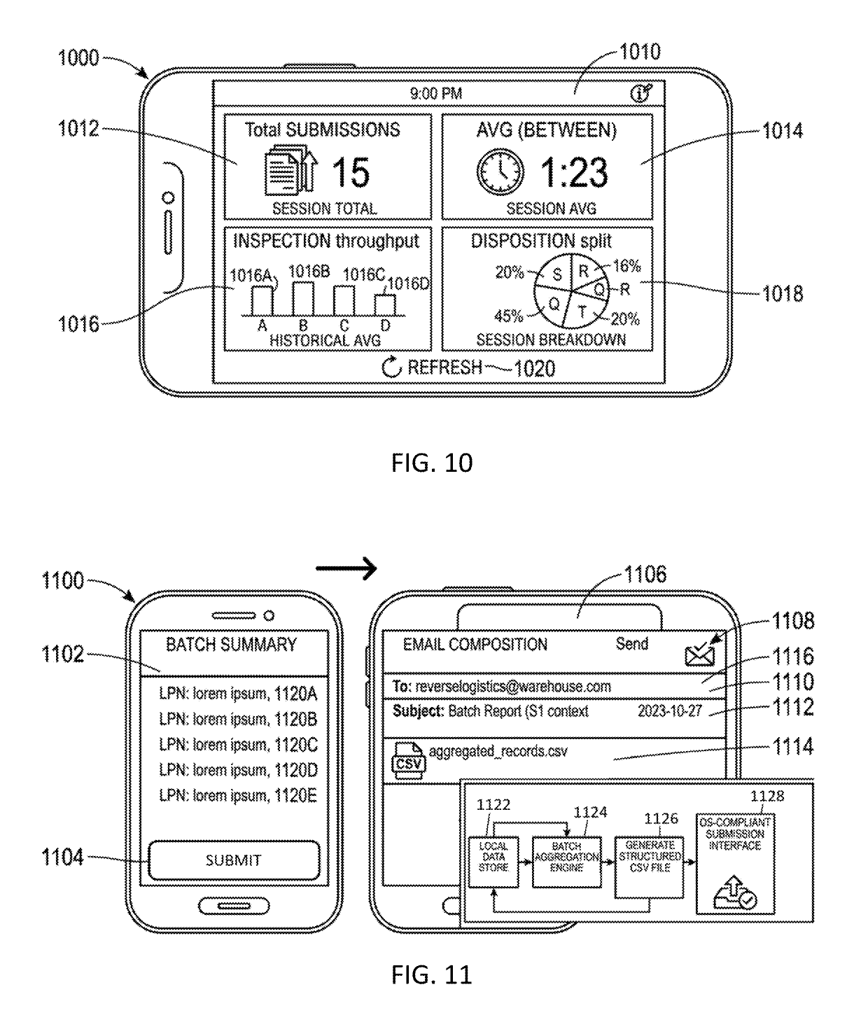

FIG. 10 illustrates a performance statistics dashboard interface 1000 in accordance with an example embodiment. The performance statistics dashboard interface 1000 may be accessible using a mobile computing device, such as the mobile computing device 108. The performance statistics dashboard interface 1000 displays information associated with performance metrics described herein. For example, the performance statistics dashboard interface 1000 can provide, e.g., display, a session count 1012. The session count 1012 can indicate to the inspector a number representative of their total sessions during a prescribed duration of time, such as during a single shift, during a portion of a shift, since the session was initiated, or any combination thereof. In an embodiment, the session count 1012 can be provided as an alphanumeric indicia. By way of another example, the performance statistics dashboard interface 1000 can include a counter, such as an average session timer 1014 which indicates a duration of an average session. By way of another example, the performance statistics dashboard interface 1000 can include historical information, such as historical session throughput 1016. The historical session throughput 1016 can define a comparison between different instances, such as between a first session 1016A, a second session 1016B, a third session 1016C, and a fourth session 1016D. The historical session throughout 1016 defines inter-session context. By way of another example, the performance statistics dashboard interface 1000 can include session breakdown information, such as a disposition breakdown 1018, which provides individual session context. For example, where a session may include returns, exchanges, marking of damaged or used goods, or the like, the disposition breakdown 1018 may be helpful for the inspector to understand session context. By way of example, if average session timer 1014 shows a longer than expected time per session and lower than average historical session throughput 1016, the inspector, his/her supervisor, and/or other interested parties may rely on the disposition breakdown 1018 to understand the reason. Where one task type takes longer to complete, lower performance may be expected.

The performance statistics dashboard interface 1000 may be reset between uses and/or at predetermined intervals or threshold conditions. In certain instances, the inspector may wish to manually reset the performance statistics dashboard interface 1000. The inspector can select a refresh 1020 interface which causes the information to reset, thereby updating local metrics.

FIG. 11 depicts a batch summary 1102 as seen on a submission interface 1100. The batch summary 1102 includes information associated with individual sessions, such as a first session 1120A, a second session 1120B, a third session 1120C, a fourth session 1120D, and a fifth session 1120E. The individual sessions may be listed in a column, in-line configuration, or other data structure. In some implementations, the inspector may be able to select a hyperlink to access individual session data, e.g., for review. Periodically, e.g., at the end of a shift, the inspector may transmit the batch summary 1102 to a reverse logistics management system. In some implementations, transmission may occur automatically upon the inspector closing the submission interface 1100. In other implementations, transmission occurs in response to the inspector selecting a user interface, such as a submit button 1104. Upon selecting the submit button 1104, the batch summary 1102, including the individual session information, may be attached 1114 to an electronic message 1106 (e.g., email). The electronic message 1106 can be automatically populated, e.g., using information stored on the mobile computing device, with a recipient address 1110, a subject 1112, other information, or any combination thereof. The inspector can select a send button 1108 to transmit the batch summary 1102.

In an embodiment, the session information is stored 1122 at a local data storage, run through a batch aggregation engine 1124 which generates 1126 the batch summary, e.g., as a CSV file, which is then submitted 1128 via an OS-compliant submission to the intended recipient.

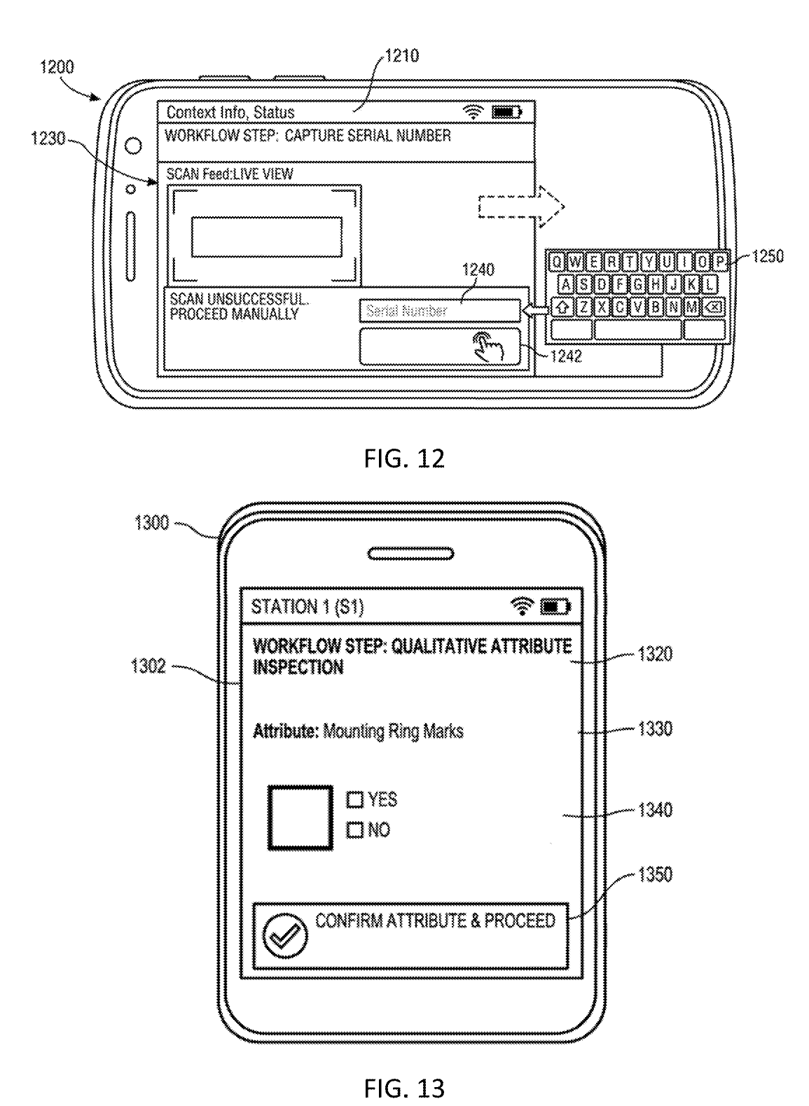

FIG. 12 depicts a fallback option 1200, such as encountered when a scan 1230 is unsuccessful (e.g., when the scan does not register a proper label). In response to an unsuccessful scan, the system can prompt a manual interaction 1240 whereby the inspector can manually enter the requested information using, e.g., a virtual keyboard 1250 and a manual entry field 1242, thereby bypassing the computer vision engine.

FIG. 13 depicts a qualitative selector 1300 whereby the inspector can input information associated with the scanned good. For example, the qualitative selector 1300 can compile information associated with the scanned good and ask the inspector to confirm the compiled information. The qualitative selector 1300 can prompt the inspector to provide information about one or more qualitative aspects of the scanned good. The qualitative selector 1300 can instruct the instructor to capture additional information, such as image data, of the scanned good.

Further aspects of the invention are provided by one or more of the following embodiments:

A computer-implemented method for digitally processing a returned physical product via an inspection interface configured to transform unstructured physical attributes into structured digital records, the method comprising: identifying, via a processor of a mobile computing device, a return context for a physical product based at least in part on a persistent station identifier; displaying, on a display of the mobile computing device, a user interface element corresponding to a first step of a system-defined, sequential inspection workflow configured to govern a hardware state transition of the mobile computing device; in response to a user interaction with the user interface element, initializing a hardware-integrated camera session of the mobile computing device to capture raw image data of a portion of the physical product; extracting, in real-time by the processor executing a local computer vision engine, captured product data from the raw image data using at least one of optical character recognition (OCR) or barcode scanning; verifying, by the processor of the mobile computing device, the captured product data against a structured data schema associated with the return context to ensure data integrity prior to record finalization; maintaining a persistent state of the persistent station identifier across a plurality of distinct inspection cycles within the workflow; storing the captured product data in a local data store to enable post-capture, pre-submission editing of a record; and upon a triggering event, automatically generating a structured digital file aggregating a plurality of records from the local data store, wherein the structured digital file is formatted for electronic transmission into a reverse logistics database, thereby synchronizing physical product state with digital record accuracy and bypassing a separate manual data transcription step.

The method of any one or more of the embodiments, wherein the structured digital file is a Comma Separated Values (CSV) file, and wherein automatically generating the structured digital file comprises automatically composing an electronic mail message with the CSV file attached for user-initiated submission via a pre-established email account on the mobile computing device.

The method of any one or more of the embodiments, wherein maintaining the persistent state of the persistent station identifier comprises fixing a station selector value or a disposition selector value for a first inspection cycle and automatically applying the fixed value to a subsequent inspection cycle until a manual user override is detected.

The method of any one or more of the embodiments, wherein extracting the captured product data in real-time further comprises executing a text-grabbing feature that displays the extracted captured product data as a text overlay on a live video feed from the hardware-integrated camera session.

The method of any one or more of the embodiments, further comprising: providing a manual data entry mode as a fallback input method for the system-defined, sequential inspection workflow; and receiving the captured product data via a virtual keyboard displayed on the display of the mobile computing device in response to a determination that the at least one of OCR or barcode scanning is unsuccessful in extracting data from the raw image data.

The method of any one or more of the embodiments, further comprising providing, via at least one of a speaker or a haptic engine of the mobile computing device, an audible or tactile confirmation to a user in response to at least one of: successfully extracting data, successfully verifying a record, or receiving a submission interaction via a submit button.

The method of any one or more of the embodiments, further comprising: calculating locally on the mobile computing device at least one performance statistic associated with the inspection workflow, wherein the at least one performance statistic includes an average time between submissions; and displaying the at least one performance statistic on the display of the mobile computing device.

The method of any one or more of the embodiments, wherein identifying the return context comprises determining the persistent station identifier via spatial proximity mapping by utilizing an ultrawideband (UWB) transceiver or a Bluetooth Low Energy (BLE) Received Signal Strength Indicator (RSSI) of the mobile computing device to detect physical coordinates relative to a fixed location beacon.

The method of any one or more of the embodiments, wherein verifying the captured product data against the structured data schema comprises cross-referencing the captured product data with locally stored return goods authorization (RGA) records on the mobile computing device to validate that the physical product corresponds to a specific unit authorized for return.

The method of any one or more of the embodiments, further comprising executing a continuous synchronization engine configured to transmit the stored captured product data to the reverse logistics database in real-time via an event-driven architecture using an industrial messaging protocol immediately upon successful verification of the record.

The method of any one or more of the embodiments, wherein the triggering event is programmatically linked to a detection of a network handshake by the mobile computing device.

The method of any one or more of the embodiments, wherein extracting the captured product data further comprises allocating specific hardware resources including a dedicated neural processing unit (NPU) or a graphics processing unit (GPU) of the mobile computing device to execute high-speed image processing algorithms of the local computer vision engine.

The method of any one or more of the embodiments, wherein extracting the captured product data comprises applying a multi-mode processing operation including a first mode that identifies a region of interest within the raw image data and maps the region of interest to a predetermined coordinate on a graphical user interface for direct pixel-accurate reproduction, and a second mode that semantically parses identifying information from the raw image data and reconstructs the identifying information using native device assets.

The method of any one or more of the embodiments, further comprising generating a spatial prompt on the display to assist a user in aligning the physical product within a field of view of the camera, and restricting advancement of the system-defined, sequential inspection workflow until the physical product is properly aligned.

A reverse logistics inspection system comprising: a mobile computing device comprising a processor, a memory, a camera, and a display, wherein the memory stores instructions that, when executed by the processor, cause the system to: identify a return context for a physical product based at least in part on a persistent station identifier; present on the display a system-defined sequence of inspection tasks configured to govern a hardware state transition of the mobile computing device; activate the camera to capture raw image data of the returned physical product in response to a prompt from a current inspection task; apply a local computer vision engine to the captured raw image data to extract captured data directly from the returned physical product via at least one of an OCR process or a barcode scanning process; immediately verify the captured data against a structured data schema associated with the return context at an edge of a network to ensure data integrity; store the captured data in a local data store to enable post-capture, pre-submission editing of a record; and based on a triggering event, automatically aggregate a plurality of records from the local data store into a structured digital file formatted for electronic transmission into a reverse logistics database.

The system of any one or more of the embodiments, wherein the instructions, when executed by the processor, further cause the system to: display a plurality of selectable disposition options including at least one of scrap, rework, quality assurance (QA), or restock after the immediate verification is completed; receive a user selection corresponding to one of the disposition options; and include the user-selected disposition option in the local data store.

The system of any one or more of the embodiments, wherein the structured digital file is a CSV file, and wherein the instructions, when executed by the processor, further cause the system to automatically compose an electronic mail message, using a pre-established email account on the mobile computing device, with the CSV file attached for user-initiated submission to a predefined recipient.

The system of any one or more of the embodiments, wherein the mobile computing device further comprises at least one of a speaker or a haptic engine, and wherein the instructions, when executed by the processor, further cause the system to provide an audible or tactile confirmation upon successfully verifying the captured data or receiving a submission interaction via a submit button.

The system of any one or more of the embodiments, wherein the instructions, when executed by the processor, further cause the system to: calculate locally on the mobile computing device a performance statistic based on an average time between submission entries; and present the performance statistic on the display.

The system of any one or more of the embodiments, wherein the instructions, when executed by the processor, further cause the system to: present a user interface on the display that enables a user to select, edit, or delete a previously stored unsubmitted record from a local history log within the memory prior to the triggering event.

The system of any one or more of the embodiments, further comprising a manual data entry mode as a fallback input method, wherein the instructions, when executed by the processor, cause the system to receive the captured data via a virtual keyboard in response to a determination that the local computer vision engine is unsuccessful in extracting data from the raw image data.

A non-transitory computer-readable medium storing instructions that, when executed by a processor of a mobile device equipped with a camera, cause the mobile device to perform a method for validating returned goods, the method comprising: identifying a return context for a physical product based at least in part on a persistent station identifier; enforcing a mandatory, sequential workflow for inspection by presenting a series of interactive prompts on a display of the mobile device configured to govern a hardware state transition of the mobile device; for at least one prompt in the workflow, initiating a live view from the camera to capture real-time identifying information from a surface of the physical product via at least one of OCR or barcode decoding using a local computer vision engine; performing, on the mobile device, a real-time integrity verification by cross-referencing the captured real-time identifying information against a structured data schema associated with the return context; maintaining a persistent state of the persistent station identifier across a plurality of distinct inspection cycles within the workflow; storing the captured real-time identifying information in a local data store to enable post-capture, pre-submission editing of a record; and subsequent to a triggering event, generating a complete and structured digital output file aggregating a plurality of records from the local data store, thereby creating a final data record at a point of physical inspection without an intermediate data entry stage.

The non-transitory computer-readable medium of any one or more of the embodiments, wherein the method further comprises: after the real-time integrity verification, presenting a plurality of selectable disposition options including at least one of scrap, rework, QA, or restock on the display; receiving a user selection of one of the disposition options; and including the user-selected disposition option in the local data store.

The non-transitory computer-readable medium of any one or more of the embodiments, wherein the structured digital output file is a CSV file, and wherein the method further comprises automatically composing an electronic mail message, using a pre-established user account, with the CSV file attached for user-initiated submission.

The non-transitory computer-readable medium of any one or more of the embodiments, wherein the mandatory, sequential workflow includes an interactive prompt requiring a manual binary input from a user confirming the presence or absence of mounting ring marks on the physical product, and wherein the binary input is included in the structured digital output file.

The non-transitory computer-readable medium of any one or more of the embodiments, wherein the method further comprises, after generating the structured digital output file: calculating locally on the mobile device a performance statistic comprising at least one of a total number of submissions or an average time between submission entries; and displaying the calculated performance statistic on the display of the mobile device.

The non-transitory computer-readable medium of any one or more of the embodiments, wherein the method further comprises: maintaining the local data store as a local history log; and providing a user interface that allows a user to select, edit, or delete a record from the local history log prior to the triggering event.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

While the present disclosure frequently references a “mobile computing device”, it should be understood that this term is intended to encompass any portable electronic system capable of data processing and sensor integration, including but not limited to smartphones, tablets, wearable computing devices (e.g., head-mounted displays or smart glasses), handheld industrial scanners, and autonomous or semi-autonomous robotic inspection platforms. Furthermore, references to specific sensors (e.g., LiDAR, camera, or UWB) are intended to include any functionally equivalent sensing modality capable of capturing the described physical or spatial attributes, such as ultrasonic sensors, radar, stereoscopic vision systems, or radio-frequency (RF) phase-detection systems.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Functional logic described herein may be implemented as software instructions stored in a non-transitory computer-readable medium, as dedicated hardware logic, or as a combination thereof.

Benefits, other advantages, and solutions to problems are described above with regard to specific embodiments. However, the benefits, advantages, solutions to problems, and any feature(s) that may cause any benefit, advantage, or solution to occur

or become more pronounced are not to be construed as a critical, required, or essential feature of any or all the claims.

What is claimed is:

1. A method for digitally processing a returned physical product via an inspection interface configured to transform unstructured physical attributes into structured digital records, the method comprising:
identifying, via a processor of a mobile computing device, a return context for a physical product based at least in part on a persistent station identifier;
displaying, on a display of the mobile computing device, a user interface element corresponding to a first step of a system-defined, sequential inspection workflow configured to govern a hardware state transition of the mobile computing device;
in response to a user interaction with the user interface element, initializing a hardware-integrated camera session of the mobile computing device to capture raw image data of a portion of the physical product;
extracting, by the processor executing a local computer vision engine, captured product data from the raw image data using at least one of optical character recognition (OCR) or barcode scanning;
verifying, by the processor of the mobile computing device, the captured product data against a structured data schema associated with the return context to ensure data integrity prior to record finalization;
maintaining a persistent state of the persistent station identifier across a plurality of distinct inspection cycles within the workflow;
storing the captured product data in a local data store to enable post-capture, pre-submission editing of a record; and
upon a triggering event, automatically generating a structured digital file aggregating a plurality of records from the local data store, wherein the structured digital file is formatted for electronic transmission into a reverse logistics database.

2. The method of claim 1, wherein the structured digital file is a Comma Separated Values (CSV) file, and wherein automatically generating the structured digital file comprises automatically composing an electronic mail message with the CSV file attached for user-initiated submission via a pre-established email account on the mobile computing device.

3. The method of claim 1, wherein maintaining the persistent state of the persistent station identifier comprises fixing a station selector value or a disposition selector value for a first inspection cycle and automatically applying the fixed value to a subsequent inspection cycle until a manual user override is detected.

4. The method of claim 1, wherein extracting the captured product data in real-time further comprises executing a text-grabbing feature that displays the extracted captured product data as a text overlay on a live video feed from the hardware-integrated camera session.

5. The method of claim 1, further comprising:
providing a manual data entry mode as a fallback input method for the system-defined, sequential inspection workflow; and
receiving the captured product data via a virtual keyboard displayed on the display of the mobile computing device in response to a determination that the at least one of OCR or barcode scanning is unsuccessful in extracting data from the raw image data.

6. The method of claim 1, further comprising providing, via at least one of a speaker or a haptic engine of the mobile computing device, an audible or tactile confirmation to a user in response to at least one of: successfully extracting data, successfully verifying a record, or receiving a submission interaction via a submit button.

7. The method of claim 1, further comprising:
calculating locally on the mobile computing device at least one performance statistic associated with the inspection workflow, wherein the at least one performance statistic includes an average time between submissions; and
displaying the at least one performance statistic on the display of the mobile computing device.

8. A reverse logistics inspection system comprising:
a mobile computing device comprising a processor, a memory, a camera, and a display, wherein the memory stores instructions that, when executed by the processor, cause the system to:
identify a return context for a physical product based at least in part on a persistent station identifier;
present on the display a system-defined sequence of inspection tasks configured to govern a hardware state transition of the mobile computing device;
activate the camera to capture raw image data of the returned physical product in response to a prompt from a current inspection task;
apply a local computer vision engine to the captured raw image data to extract captured data directly from the returned physical product via at least one of an OCR process or a barcode scanning process;
immediately verify the captured data against a structured data schema associated with the return context at an edge of a network to ensure data integrity;
store the captured data in a local data store to enable post-capture, pre-submission editing of a record; and
based on a triggering event, automatically aggregate a plurality of records from the local data store into a structured digital file formatted for electronic transmission into a reverse logistics database.

9. The system of claim 8, wherein the instructions, when executed by the processor, further cause the system to:
display a plurality of selectable disposition options including at least one of scrap, rework, quality assurance (QA), or restock after the immediate verification is completed;
receive a user selection corresponding to one of the disposition options; and
include the user-selected disposition option in the local data store.

10. The system of claim 8, wherein the structured digital file is a CSV file, and wherein the instructions, when executed by the processor, further cause the system to automatically compose an electronic mail message, using a pre-established email account on the mobile computing device, with the CSV file attached for user-initiated submission to a predefined recipient.

11. The system of claim 8, wherein the mobile computing device further comprises at least one of a speaker or a haptic engine, and wherein the instructions, when executed by the processor, further cause the system to provide an audible or tactile confirmation upon successfully verifying the captured data or receiving a submission interaction via a submit button.

12. The system of claim 8, wherein the instructions, when executed by the processor, further cause the system to:
calculate locally on the mobile computing device a performance statistic based on an average time between submission entries; and
present the performance statistic on the display.

13. The system of claim 8, wherein the instructions, when executed by the processor, further cause the system to:
present a user interface on the display that enables a user to select, edit, or delete a previously stored unsubmitted record from a local history log within the memory prior to the triggering event.

14. The system of claim 8, further comprising a manual data entry mode as a fallback input method, wherein the instructions, when executed by the processor, cause the system to receive the captured data via a virtual keyboard in response to a determination that the local computer vision engine is unsuccessful in extracting data from the raw image data.

15. A non-transitory computer-readable medium storing instructions that, when executed by a processor of a mobile device equipped with a camera, cause the mobile device to perform a method for validating returned goods, the method comprising:
identifying a return context for a physical product based at least in part on a persistent station identifier;
enforcing a mandatory, sequential workflow for inspection by presenting a series of interactive prompts on a display of the mobile device configured to govern a hardware state transition of the mobile device;
for at least one prompt in the workflow, initiating a live view from the camera to capture real-time identifying information from a surface of the physical product via at least one of OCR or barcode decoding using a local computer vision engine;
performing, on the mobile device, a real-time integrity verification by cross-referencing the captured real-time identifying information against a structured data schema associated with the return context;
maintaining a persistent state of the persistent station identifier across a plurality of distinct inspection cycles within the workflow;
storing the captured real-time identifying information in a local data store to enable post-capture, pre-submission editing of a record; and
subsequent to a triggering event, generating a complete and structured digital output file aggregating a plurality of records from the local data store, thereby creating a final data record at a point of physical inspection without an intermediate data entry stage.

16. The non-transitory computer-readable medium of claim 15, wherein the method further comprises:
after the real-time integrity verification, presenting a plurality of selectable disposition options including at least one of scrap, rework, QA, or restock on the display;
receiving a user selection of one of the disposition options; and
including the user-selected disposition option in the local data store.

17. The non-transitory computer-readable medium of claim 15, wherein the structured digital output file is a CSV file, and wherein the method further comprises automatically composing an electronic mail message, using a pre-established user account, with the CSV file attached for user-initiated submission.

18. The non-transitory computer-readable medium of claim 15, wherein the mandatory, sequential workflow includes an interactive prompt requiring a manual binary input from a user confirming the presence or absence of mounting ring marks on the physical product, and wherein the binary input is included in the structured digital output file.

19. The non-transitory computer-readable medium of claim 15, wherein the method further comprises, after generating the structured digital output file:
calculating locally on the mobile device a performance statistic comprising at least one of a total number of submissions or an average time between submission entries; and
displaying the calculated performance statistic on the display of the mobile device.

20. The non-transitory computer-readable medium of claim 15, wherein the method further comprises:
maintaining the local data store as a local history log; and
providing a user interface that allows a user to select, edit, or delete a record from the local history log prior to the triggering event.
